(19) United States
(12) Patent Application Publication
(10) Pub. No.: US 2006/0100334 A1
(43) Pub. Date: May 11, 2006

(54) Polyamide molding compounds having ultrafine fillers and light-reflecting components producible therefrom

(75) Inventors: Martina Ebert, Domat/Ems (CH); Georg Stoppelmann, Bonaduz (CH)

Correspondence Address: BROWDY AND NEIMARK, P.L.L.C.;624 NINTH STREET, NW, SUITE 300, WASHINGTON, DC, 20001-5303, US

(73) Assignee: EMS-CHEMIE AG, DORMAT/EMS (CH)

(21) Appl. No.: 10/526,767

(22) PCT Filed: Aug. 26, 2003
(86) PCT No.: PCT/EP03/09420

§ 371 Date: Nov. 3, 2005

(30) Foreign Application Priority Data
Sep. 6, 2002 (CH) 1520/02

(51) Int. Cl. C08K 3/26

(52) U.S. Cl. 524/425

(57) ABSTRACT

A polyamide molding compound is disclosed having a partially crystalline poly-amide, which includes partially aromatic copolyamides and classic mineral fillers and is distinguished in that the mineral filler is ultrafine chalk (CaCO₃) and has an average particle size of at most 100 nm. The polyamide molding compound preferably includes at most 40 weight-percent ultrafine chalk. This polyamide molding compound is preferably used for the production of reflectors and/or sub-reflectors of vehicle driving illuminators with subsequent, direct metal coating.

The present invention relates to polyamide molding compounds according to independent dependent claim 1 and blanks and light-reflecting components producible therefrom.

Thermoplastics, from which light-reflecting components are produced through injection molding and subsequent metallization (vacuum deposition, typically using aluminum), are known. Such components are headlight reflectors for automobiles, for example. In addition to the paraboloid headlights which were previously used exclusively, two basic types have been developed which are optimized in regard to light usage and occupied space, the projection headlight (ellipsoid, polyellipsoid) and the free-form headlight. Since the cover disks of free-form headlights in particular may usually be designed without profiling because of the optimized light usage and distribution of this type of reflector, currently transparent disks made of polycarbonate or glass are used. This increases the requirements for the surface quality of elements which are easily visible from the outside (e.g., reflector, sub-reflector, frame), the dimensional stability in heat, the mechanical strength, simple processing, and low manufacturing tolerances also being important.

Such headlight reflectors may also be subdivided into the actual reflector, which essentially has a paraboloid shape, and a sub-reflector, which deviates more or less from the paraboloid shape. The reflector is the actual component, which reflects light in a targeted way for the desired illumination, and which is normally positioned directly surrounding the incandescent bulb which produces the light. In addition to light, the bulb also produces heat, so that the reflector is subjected to an operating temperature of approximately 180-210° C., depending on its construction. For peak temperatures of more than 220° C. or if the optical requirements are not too high, experience has shown that only sheet metal is used as a reflector material.

The part of the light-reflecting component which is farther away from the light source is called the sub-reflector. Sub-reflectors often cover the region between the reflector and the bulb housing and/or the remaining vehicle body or even the transparent bulb covering. Sub-reflectors therefore do not have to have a paraboloid extension which is used to increase the light yield, rather, they may fulfill an aesthetic object in that they represent a reflecting surface which appears to enlarge the reflector. Because of the greater distance from the light source, an operating temperature of at most approximately 150° C. is to be expected for sub-reflectors.

Metal coatings which are applied to the sub-reflectors to improve the reflection on the surfaces of the reflectors and to produce an aesthetic impression are not subjected to any direct mechanical stress, such as abrasion. Nonetheless, good adhesion of the metal coating on the reflector and sub-reflector surfaces is important, since blistering or even flaking may impair the light yield and worsen the aesthetic impression. In the following, the term “reflector” always also refers to sub-reflectors if no express differentiation is made between reflectors and sub-reflectors.

The metallization of the reflectors is typically performed in vacuum by means of vapor deposition using PVD methods (PVD=physical vapor deposition, e.g., deposition or sputtering of aluminum, for example) and/or CVD methods (CVD=chemical vapor deposition, such as plasma-enhanced CVD). An important requirement for the plastic is therefore a low outgassing rate under the corresponding vacuum and temperature conditions. In order that the metal coatings of the reflectors are not damaged in operation, no increased outgassing may occur even at the high operating temperatures cited. In addition, the reflectors are to be dimensionally stable in a temperature range from −50° C. to 220° C., i.e., the expansion and contraction behavior is to be as isotropic as possible, so that—at least for the reflectors—the light yield and/or light bundling is not impaired. The metal coatings preferably have expansion and contraction behavior which is essentially identical to that of the reflectors, so that the tensile and/or shearing load of the reflective coatings is as small as possible. In this way, the danger of cracking or buckling in the reflective coatings is also reduced.

A further requirement relates to the surface qualities of the (usually curved) plastic surface to be coated. Especially for reflectors in which the light yield is essential, a smooth, high-gloss surface which is as homogeneous as possible must be provided for the coating. Plastics which flow poorly or solidify too early and/or an addition of fillers often leads to a rough, matte, or irregular impression in the injection mold, measured by the extremely high requirements of a mirror-smooth surface, even if the corresponding surface of the molding tool is polished to a high gloss.

Until now, duroplastics, and also, more rarely, thermoplastics, were used to produce reflectors. Of the latter, the amorphous thermoplastics primarily used, e.g., polyether imide (PEI) or polyether sulfones (PES and/or PSU or PPSU) have a high glass transition temperature (Tg). These amorphous high-Tg thermoplastics (HT thermoplastics) may be used without fillers to produce reflector blanks having outstanding surface gloss. The reflector blanks may be metallized directly. However, the high price of these amorphous HT thermoplastics is disadvantageous for mass production. The highest temperatures occur in the illumination unit, of course. Therefore, until now either the reflectors were made of sheet metal or metallized injection molded parts were produced from duroplastic (BMC) or amorphous HT thermoplastics (PC-HT, PEI, PSU, PES). The high tolerance requirements, coupled with the surface quality of the injection molded parts necessary for metallization, were fulfilled until now only by unfilled amorphous HT thermoplastics or enameled duroplastics, so that the use of partially crystalline materials was generally excluded.

Through the introduction of clear glass lenses, which are overwhelmingly used on the European market in the newer vehicle models, the frames or sub-reflectors have acquired great significance, and they are typically completely metallized. In addition to the basic function of the frames as a component of the main headlight for tailoring to fender and/or engine hood geometries and illumination functions, stylistic features are increasingly coming to the foreground. Essential requirements of the frames are (similarly to the reflectors) easy processability, outstanding surface quality, easy metallization, resistance to environmental influences and moisture, temperature stability, and dimensional stability. In addition to these traditional functions, further functional units, such as reflectors for turn signals, are increasingly integrated into the frames and/or the sub-reflector. In order to fulfill this requirement profile, until now a wide palette, from technical plastics to polymer blends to HT thermoplastics, was used. Examples are polyamide, polycarbonate, polysulfone (but not polyolefins) as well as blends based on PC, but especially on PBT. HT thermoplastics are used to achieve special thermal requirements (iridescence temperature up to 212° C. for Ultrason E from BASF, Ludwigshafen, Germany), the use of which is limited for economic reasons, however. In the course of the continuing reduction of complexity, increasing integration of headlight components into highly developed illumination systems is occurring, which will have higher material requirements (J. Queisser, M. Geprägs, R. Blum and G. Ickes, Trends bei Automobilscheinwerfern [Trends in Automobile Headlights], Kunststoffe [Plastics] 3/2002, Hanser Verlag, Munich).

The partially crystalline polyphenylene sulfide (PPS), which is cited in European Patent 0 332.122 for the production of headlight reflectors, for example, also has very high thermal dimensional stability. In this case, a production method is disclosed in which a reflector blank (using at most 250/% carbon black to achieve increased electrical conductivity) is injection molded in a first work step. In a second work step, the reflector blank is electrostatically enameled to compensate for irregularities and to achieve a glossy surface, and in a third work step, it is aluminized in vacuum. This method is generally considered too complicated and too expensive for the mass production of reflectors, due to this additional enameling step. In addition, it is considered disadvantageous that the addition of fillers reduces the flowability of an injection molding compound and roughens the sur-face of the blanks produced in this way.

Compositions are known from European Patent 0 696 304 which include (a) a first polyamide, produced from an aromatic carboxylic acid component (isophthalic acid and/or terephthalic acid) and an aliphatic diamine component (hexamethylene diamine and 2-methyl-1,5-pentamethylene diamine); (b) a second aliphatic (polyamide 66, polyamide 6, or polyamide 46) or partially aromatic polyamide, which differs from the first polyamide; and (c) a mineral filler (kaolin, talc, mica, or wollastonite). It is disclosed in European Patent 0 696 304 that corresponding compositions having a high filler component of kaolin or mica (at least 40%) may reach an HDT/A value of more than 200° C., but a glossy surface is only observed in the cases in which the composition also includes 10% glass fibers. However, the addition of such glass fibers also impairs the flowability of the composition during injection molding of molded parts and leads to an uneven surface and to less isotropic and/or more anisotropic contraction behavior.

Compositions are known from Japanese Patent 11 279 289 and Japanese Patent 11 303 678, which include granular metallic fillers made of Al, Ni, Sn, Cu, Fe, Au, Ag, Pt, or alloys such as brass or stainless steel (but particularly preferably Al) and from which molded parts having a metal-colored surface may be produced. The metallic impression of the surface of a corresponding molded part is decisively determined by the grain size of the metal particles, whose useful average diameter is to be between 10 μm and 200 μm. If possible however, the use of such particulate metal additives is to be dispensed with for reasons of easier reclamation and/or recycling of the materials in the production of new components.

A material for producing streetlight reflectors is known under the name Minlon® (E.I. du Pont de Nemours & Co., Wilmington, USA). The product cited is nylon 66 (PA 66) which, in addition to a heat stabilizer, also includes 36-40% classic mineral materials. However, this material does not appear to be suitable for vehicle travel illuminators due to the surface quality.

Film applications are known from German Patent 198 47 844, in which a crystallizable polymer is admixed with at most 1% nanoscale fillers as a nucleation agent to improve the crystallization and therefore to improve the film properties. Thus, molded parts having higher rigidity, hardness, abrasion resistance, and toughness and/or films having good transparency and high gloss were achieved.

The object of the present intervention is to suggest an alternative material, using which injection-molded reflectors may be produced having ah at least approximately equally good surface (which is suitable for direct coating using a metal coating) and at least approximately equally good thermal dimensional stability as using the materials known from the related art.

This object is achieved by the features of independent claim 1. Preferred embodiments and further features result from the dependent claims.

The material according to the present intervention is a polyamide molding compound having a partially crystalline polyamide and a mineral filler, the mineral filler having an ultrafine grain with an average particle size of at most 100 nm.

The concept of polyamide is understood to include homopolyamides, copolyamides, and mixtures of homopolyamides and/or copolyamides.

The preferred partially aromatic copolyamides are based on the monomers hexamethylene diamine and aromatic dicarboxylic acids. A partially aromatic copolyamide based on hexamethylene diamine, and terephthalic acid and isophthalic acid in the ratio 70/30 (i.e., one corresponding to PA 6T/6I) is especially preferred. The preferred mineral filler for the partially aromatic copolyamide is ultrafine chalk (CaCO₃), the polyamide molding compound preferably including at most 40 weight-percent thereof. The ultrafine chalk advantageously has an average particle diameter of at most 90 nm, preferably an average particle diameter of at most 80 nm, and especially preferably an average particle diameter of 70. nm.

Polyamide nanocomposites having good thermal dimensional stability are known from European Patent 0 940 430. The use of this polyamide composition for housings or mechanical parts in electrical equipment or electronics (e.g., switches or plugs), external or internal parts on automobiles, and gear or bearing housings in mechanical engineering is disclosed. No specific use for directly coated reflectors in automobiles is disclosed in this document. In addition, European Patent 0 940 430 provides no information on parameters essential in this regard, such as gloss or iridescence temperature. However, blanks may be injection molded from the polyamide molding.-compound of the present invention which, in spite of the filler component, are distinguished by a smooth surface having high gloss in the region where the mold was polished to a high gloss. This is even more astounding because, in comparison to the amorphous, unfilled high-Tg thermoplastics, both the crystallization during the solidification of the molding compound and the filler reduce the flowability and molding precision of the molding compound. Such blanks are especially suitable for direct metallization (e.g., using PVD methods) and use as reflectors.

The polyamide molding compounds according to the present invention (examples 1 and 2) were produced on a 30 mm double-screw extruder ZSK 25 from Werner. & Pfleiderer at temperatures between 320° C. and 340° C. In this case, the polyamide was dosed into the intake and the minerals were dosed separately into the intake. Ultrafine, uncoated, precipitated calcium carbonate having the product name “SOCAL® U1” (Solvay Chemicals S.A.) in the form of cubical particles with an average size of 70 nm was used as the mineral.

The following minerals, which are not according to the present invention, were used in comparative examples 3 to 6:
CaCO₃ type 2: natural, milled CaCO₃ having an average particle diameter of 3 μm, a density of 2.7 g/cm³ and a pH value of 9 and a degree of whiteness of 90% according to DIN 53163.
CaCO₃ type 3: precipitated CaCO₃, fine, having an average particle diameter of 0.2 μm, a specific surface area of 11 m²/g, a density of 2.9 g/cm³, and a pH value of 10.
Kaolin: calcined kaolin, treated with aminosilane, having an average particle diameter of 1.3 μm, a density of 2.6 g/cm³ and a pH value of 9.

The testing of the molding compounds according to the present invention and not according to the present invention (cf. Table 1) was performed according to the following guidelines:
density according to ISO 11&3
tensile modulus of elasticity according to ISO 527
HDT A, B, and C according to ISO 75

To determine the surface quality of the molding compounds according to the present invention, slabs were produced in injection molds, polished to a high gloss, at a compound temperature of 340° C., a mold temperature of 140° C., and an injection speed of 30 mm/sec., and these slabs were subsequently graded visually.

TABLE 1

| | | | Example | Example | Comparative example | | | |
|---|---|---|---|---|---|---|---|---|
| | | | 1 | 2 | 3 | 4 | 5 | 6 |
| PA 6T/6I (70/30%) | | Weight- | 70 | 60 | 100 | 80 | 80 | 60 |
| | | percent | | | | | | |
| CaCO₃ type 1 | Particle | Weight- | 30 | 40 | | | | |
| (ultrafine chalk) | size | percent | | | | | | |
| | 70 nm | | | | | | | |
| CaCO₃ type 2 | | Weight- | | | | 20 | | |
| | | percent | | | | | | |
| CaCO₃ type 3 | | Weight- | | | | | 20 | |
| | | percent | | | | | | |
| Kaolin | | Weight- | | | | | | 40 |
| | | percent | | | | | | |
| Density | dry | g/cm³ | 1.44 | 1.53 | 1.21 | | | 1.55 |
| Tensile modulus of | dry | MPa | 5500 | 6500 | 4050 | | | 7500 |
| elasticity, 23° C. | | | | | | | | |
| Tensile modulus of | dry | MPa | 1250 | | 600 | | | |
| elasticity, 150° C. | | | | | | | | |
| HDT A (1.8 MPa) | dry | ° C. | 140 | 140 | 130 | | | 145 |
| HDT B (0.45 MPa) | dry | ° C. | 240 | | | | | 255 |
| HDT C (8 MPa) | dry | ° C. | 120 | 120 | 115 | | | 115 |
| Surface quality | | — | Very | Very | Good | Poor | Good | Poor |
| | | | good | good | | | | |

Blanks according to the present invention, based on partially crystalline, partially aromatic copolyamides, are suitable, due to their high thermal dimensional stability (high HDT/A value and high melting temperature), for use as actual reflectors in the hot region of vehicle driving illuminators, i.e., as reflectors in automobile headlights or in headlights of other vehicles, for example. Such blanks may 10 also be considered for the production of reflectors for other light facilities (e.g., stationary facilities). This astounding suitability (in consideration of the related art up to this point) is best expressed by an iridescence temperature which is preferably over 220° C. According to the above-mentioned magazine Kunststoffe, the highest iridescence temperature previously reported was 212° C.

If the temperature is increased in steps, the iridescence temperature is known to characterize the value at which the reflective layer begins to display iridescence, which is caused by mechanical distortion between the polymer background and the metal coating because of the differing thermal expansion of these materials. An iridescence temperature of approximately 240° C. was measured on a reflector, produced according to the present invention, based on PA 6T/6I (70/30). In this case, the polyamide molding compound contained 30 weight-percent ultra-fine chalk having an average particle size of 70 nm. Using the polyamide molding compounds according to the present invention, cost-effective achievements of the object may be made available as a replacement for more expensive materials for both reflector temperature ranges, but particularly for the hot range of vehicle driving illuminators.

It is also to be noted that the polyamide molding compounds may also contain typical additives, such as stabilizers (of differing types), flame retardants, auxiliary processing materials, antistatic agents, and further additives, in addition to the filler according to the present invention. Thus, the polyamide molding compounds of all the examples cited each also contained a heat stabilizer.

Admixing of the mineral filler to the polyamide in a double-screw extruder (compounding) is preferred as the method of producing the polyamide molding compounds. Instead of one single type of polyamide, the use of a polyamide blend is also possible. The polyamide molding compounds according to the present invention are preferably used for the injection molding of reflectors (and/or sub-reflectors). To obtain especially precise reflector surfaces, the gas injection molding technique (see PLASTVERARBEITER [Plastics Processor], May 2002, published by Hüthig Verlag, D-69121 Heidelberg, for example) may be used during injection molding in a special version.

1. A polyamide molding compound having a partially crystalline polyamide, which includes partially aromatic copolyamides and classic mineral fillers, characterized in that the mineral filler is ultrafine chalk (CaCO₃) and has an average particle size of at most 100 nm.

2. The polyamide molding compound according to claim 1, characterized in that it includes at most 40 weight-percent ultrafine chalk.

3. The polyamide molding compound according to claim 1, characterized in that the ultrafine chalk has an average particle size of at most 90 nm.

4. The polyamide molding compound according to claim 1, characterized in that the partially aromatic copolyamides are based on the monomers hexamethylene diamine and aromatic dicarboxylic acids.

5. The polyamide molding compound according to claim 4, characterized in that the aromatic dicarboxylic acids include terephthalic acid and isophthalic acid in the ratio 70/30.

6. A blank made of an injection-molded polyamide molding compound according to claim 1, characterized in that it includes a smooth surface having a high gloss, produced by a molding tool polished to a high gloss.

7. A reflector for vehicle driving illuminators, turn signals, or street lamps, and/or a sub-reflector for vehicle driving illuminators characterized in that it includes a blank according to claim 6 and is metallized directly.

8. The reflector and/or sub-reflector according to claim 7, characterized in that the metal coating is applied through PVD methods and the iridescence temperature is at a value which is higher than 220° C.

9. A method of producing a polyamide molding compound having a partially crystalline polyamide, which includes partially aromatic copolyamides and classic mineral fillers, characterized in that the mineral filler is ultrafine chalk (CaCO₃), has an average particle size of at most 100 nm, and is admixed to the polyamide using a double-screw extruder.

10. The method according to claim 9, characterized in that the polyamide and at most 40 weight-percent ultrafine chalk are each separately dosed into the intake of the double-screw extruder.

11. A method of using a polyamide molding compound according to claim 1 comprising injection molding said molding compound into a reflector or sub-reflector for vehicle driving illuminators or reflectors of turn signals or street lights.

12. The use of a polyamide method according to claim 11, characterized in that a gas injection molding technique is used during said injection molding.

13. The polyamide molding compound of Claim 3 wherein said average particle size is at most 80 nm.

14. The polyamide molding compound according to claim 2, characterized in that the ultrafine chalk has an average particle size of at most 70 nm.
